(19) United States
(12) Patent Application Publication
(10) Pub. No.: US 2026/0359004 A1
(43) Pub. Date: Nov. 12, 2026

(54) COMPARISON CIRCUITRY

(71) Applicant: Arm Limited, Cambridge (GB)

(72) Inventors: David Raymond LUTZ, Austin, TX (US); Thomas ELMER, Austin, TX (US); Harsha VALSARAJU, Austin, TX (US); Yves Thomas LAPLANCHE, Valbonne (FR)

(21) Appl. No.: 19/199,623

(22) Filed: May 6, 2025

(51) Int. Cl. G06F 7/02; G06F 7/499; G06F 9/30

(52) U.S. Cl. CPC G06F 7/026; G06F 7/49973; G06F 9/30021

(57) ABSTRACT

An apparatus, comprising first and second comparison circuitry to perform first and second comparison operations to determine first and second results representing a target extreme value of first and second sets of comparison values, the first and second comparison operations comprising determining portions of the first and second results in reducing order of significance starting from a most significant portion. The first comparison circuitry provides portions of the first result to the second comparison circuitry independent of whether any a less significant portion of the first result has been determined, and the second comparison circuitry determines a given portion of the second result when a corresponding portion of each of the second set of comparison values has been made available to the second comparison circuitry, independent of whether any less significant portions of each of the second set of comparison values have been made available to the second comparison circuitry.

### BACKGROUND

### Technical Field

The present technique relates to the field of data processing.

### Technical Background

Data processing apparatuses perform operations on data values. In many workloads there may be a need to identify a maximum or minimum value within a set of data values. Such an operation may be a relatively common aspect of data processing, meaning that an improved approach for identifying the maximum or minimum value can have significant benefits for the data processing apparatus overall.

### SUMMARY

At least some examples of the present technique provide an apparatus, comprising:
first comparison circuitry configured to perform a first comparison operation to determine a first result representing a target extreme value of a first set of comparison values, the first comparison operation comprising determining portions of the first result in reducing order of significance starting from a most significant portion of the first result; and
second comparison circuitry configured to perform a second comparison operation to determine a second result representing the target extreme value of a second set of comparison values represented by the first result and at least one further comparison value, the second comparison operation comprising determining portions of the second result in reducing order of significance starting from a most significant portion of the second result;
wherein the first comparison circuitry is configured to provide a portion of the first result to the second comparison circuitry independent of whether a less significant portion of the first result has been determined; and
the second comparison circuitry is configured to determine a given portion of the second result when a corresponding portion of each of the second set of comparison values has been made available to the second comparison circuitry, independent of whether less significant portions of each of the second set of comparison values have been made available to the second comparison circuitry.

At least some examples provide a method, comprising:
performing a first comparison operation to determine a first result representing a target extreme value of a first set of comparison values, the first comparison operation comprising determining portions of the first result in reducing order of significance starting from a most significant portion of the first result;
providing each portion of the first result to a second comparison operation independent of whether a less significant portion of the first result has been determined;
performing the second comparison operation to determine a second result representing a target extreme value of a second set of comparison values represented by the first result and at least one further comparison value, the second comparison operation comprising determining portions of the second result in reducing order of significance starting from a most significant portion of the second result; and
determining a given portion of the second result when a corresponding portion of each of the second set of comparison values has been made available, independent of whether less significant portions of each of the second set of comparison values have been made available.

At least some examples provide computer-readable code for fabrication of an apparatus comprising:
first comparison circuitry configured to perform a first comparison operation to determine a first result representing a target extreme value of a first set of comparison values, the first comparison operation comprising determining portions of the first result in reducing order of significance starting from a most significant portion of the first result; and
second comparison circuitry configured to perform a second comparison operation to determine a second result representing a target extreme value of a second set of comparison values represented by the first result and at least one further comparison value, the second comparison operation comprising determining portions of the second result in reducing order of significance starting from a most significant portion of the second result;
wherein the first comparison circuitry is configured to provide each portion of the first result to the second comparison circuitry independent of whether a less significant portion of the first result has been determined; and
the second comparison circuitry is configured to determine a given portion of the second result when a corresponding portion of each of the second set of comparison values has been made available to the second comparison circuitry, independent of whether less significant portions of each of the second set of comparison values have been made available to the second comparison circuitry.

The computer-readable code may be provided on a computer-readable storage medium. The storage medium may be non-transitory.

Further aspects, features and advantages of the present technique will be apparent from the following description of examples, which is to be read in conjunction with the accompanying drawings.

### BRIEF DESCRIPTION OF THE DRAWINGS

FIG. 1 schematically illustrates first comparison circuitry and second comparison circuitry;

FIG. 2 schematically illustrates comparison operations performed on input values A, B, and C;

FIG. 3 schematically illustrates a 3-level binary tree of 2-input comparators;

FIG. 4 schematically illustrates an approach to perform a bitwise comparison operation to compare two 9-bit inputs a[8:0] and b[8:0] to determine the maximum value max[8: 0];

FIG. 5 illustrates addition of a most significant bit to two's complement values;

FIG. 6 schematically illustrates an approach to perform a bitwise comparison operation to compare two 9-bit inputs a[8:0] and b[8:0] to determine the minimum value min[8: 0];

FIG. 7 is a flow diagram schematically illustrating a method for performing a first comparison operation to determine an extreme data value of a first set of comparison values;

FIG. 8 is a flow diagram schematically illustrating a method for performing a second comparison operation to determine an extreme data value of a second set of comparison values;

FIG. 9 is a flow diagram illustrating a method of using history values to perform the first or second comparison operation between two comparison values;

FIG. 10 provides a specific example to determine the maximum value of the inputs A and B;

FIG. 11 schematically illustrates a full 2-level binary tree for determining a maximum value of four inputs;

FIG. 12 schematically illustrates timing of comparison operations performed on input values in a 2-level binary tree; and

FIG. 13 illustrates a system and a chip-containing product.

### DESCRIPTION OF EXAMPLES

As described above, many data processing workloads may require a maximum or minimum data value (herein referred to generally as an extreme data value) to be identified from a set of comparison data values. For example, there may be a desire to identify the largest vector element within a data vector during SIMD arithmetic. It will be appreciated that the source of the data values and the purpose for identifying the extreme data value are not particularly limited, and for various purposes a data processing apparatus may provide circuitry for identifying the extreme value among a set of data values.

A comparison between two values may be performed in a single comparison operation. When comparing more than two input data values, circuitry may be provided to perform a series of comparisons to compare groups (e.g., pairs) of the inputs. An input set of data values may be partitioned into groups (e.g., pairs), and at a first level separate comparisons may determine intermediate results representing the target extreme data value (i.e., the maximum or minimum) of each group of input data values. At a subsequent level, further comparisons may determine the target extreme data value of groups of the intermediate results, and so on until a final result is determined representing the overall extreme value of the input data values. Each level of comparison therefore narrows down the options for the overall extreme value by performing comparisons between values provided by a previous level (and/or new inputs introduced at that level). A binary tree of comparators is an example of such an approach. For instance, for comparing 8 input values, 3 levels of comparison can be used, with the first level performing comparisons on 4 pairs of the 8 inputs, the second level performing comparisons on 2 pairs of the 4 extreme values of each pair in the first level, and the third level performing a single comparison on the pair of extreme values identified in the second level to identify the extreme data value of the 8 input values.

According to a conventional approach, each individual comparison may be performed using an adding circuit to perform a subtraction. For determining the extreme data value of two inputs, the adder circuitry may subtract one value from the other and the carry out (cout) signal of the adder can be examined to determine the outcome. For instance, to compare the two unsigned values a and b, the operation a-b may be performed, and if cout==1 then a>=b and if cout==0 then a<b.

The inventors have realised that the approach of using subtraction to identify an extreme value does not scale well when performing comparisons on more than two input values in a multi-level tree of comparators. In particular, for each individual comparison, the full subtraction operation must be performed to identify which value should be used in a subsequent level of comparisons, before moving on to the next level of the tree. This means that, for each additional level in the tree, the overall delay is increased by the full delay of the subtraction operation. For instance, the delay of a 3 level 8-input binary comparison tree is 3 times the delay of a 1 level 2-input comparison, the delay of a 4 level 16-input comparison is 4 times the delay of the 2-input comparison, and so on. Hence, even though the time taken to perform an individual subtraction operation may be fairly low, the time taken to perform a multi-level tree of subtractions can scale poorly with increasing numbers of comparison values.

According to examples of the present techniques, first comparison circuitry is provided to perform a first comparison operation to determine a first result (an intermediate result) representing a target extreme value (e.g., a maximum or minimum) of a first set of comparison values, the first comparison operation comprising determining portions of the first result in reducing order of significance starting from a most significant portion of the first result.

Second comparison circuitry is provided to perform a second comparison operation to determine a second result representing the target extreme value of a second set of comparison values represented by the first result and at least one further comparison value, the second comparison operation comprising determining portions of the second result in reducing order of significance starting from a most significant portion of the second result.

The first comparison circuitry is configured to provide portions of the first result to the second comparison circuitry independent of whether a less significant portion of the first result has been determined. For instance, portions of the first result may be provided to the second comparison without waiting for any less significant portion to be determined. Therefore, a portion of the first result may be provided to the second comparison circuitry before the full first result has been determined. The second comparison circuitry is configured to determine a given portion of the second result when a corresponding portion of each of the second set of comparison values has been made available to the second comparison circuitry, independent of whether less significant portions of each of the second set of comparison values have been made available to the second comparison circuitry. Therefore, the second comparison circuitry does not wait until the second set of comparison values are available in full before beginning the second comparison operation.

The inventors have recognised that, when performing a portion-wise comparison to determine an extreme value of a set of comparison values, by working in decreasing order of significance from the most significant portion of a set of comparison values, portions of the result value can be determined before the full result value is known. Similarly, portions of the result value can be determined before the full input comparison values are known. For instance, when comparing the values a=100 and b=011 (for which the maximum is a, i.e., max(a, b)=100), it can be determined that the most significant bit of max(a, b) is 1, without knowing any of the less significant bits of max(a, b) and from only looking at the first bit of the inputs (and not looking at any less significant bits).

The present techniques leverage these observations by providing circuitry which allows comparisons in subsequent levels to be overlapped with comparisons in earlier levels. In particular, the first comparison circuitry can provide portions of the first result to the second comparison circuitry before the full first result is known. The second comparison circuitry can then begin determining the second result before the full values of the second set of comparison values are known (and hence before the full first result has been calculated). The inventors have realised that this allows a target extreme value to be determined for a set of input values in less time compared to techniques requiring the full result of each comparison to be known before moving on to the next level (e.g., when using adding circuitry to perform a subtraction operation at each level), as the overall comparison time scales well with the number of input values. For instance, for each additional level in a tree of comparators configured as described herein (e.g., each time the total number of inputs is doubled in the case of a binary tree) the overall time taken to perform the comparison may only increase by the time taken to perform a single portion of a comparison operation (rather than a full comparison operation, as would be required in the case of using adders to perform a subtraction operation to calculate each result). As each portion of each comparison operation may be determined with simple logic having a small delay, the number of comparison values can be increased significantly whilst having a small impact on overall comparison time. The inventors have also realised that, due to the simple logic used for the portion-wise comparison (e.g., compared to adding logic) the total power cost of using the present technique can also be significantly reduced when compared to previous techniques.

The present techniques would be counter-intuitive compared to the approach of using adder circuitry to perform a subtraction operation to determine the first result and the second result, since the portion-wise first and second comparison operations can be considerably slower than a subtraction operation. That is, the full first comparison operation performed by the first comparison circuitry may be significantly slower than determining the first result using subtraction (and similarly for the second comparison operation). However, because the full first result does not need to be known before the second comparison operation may start, and therefore significant portions of the first comparison operation and the second comparison operation may be performed at the same time, the inventors have realised that the total time to perform the first comparison and the second comparison operation can be reduced compared to performing two subtraction operations (and scales better as further levels of comparison may be added), and therefore performance can be counter-intuitively improved.

As the first comparison circuitry provides a result to be compared with the further comparison value by the second comparison circuitry, the first comparison circuitry and second comparison circuitry can be considered comparators at subsequent levels of a comparison tree. It will be appreciated that ‘first’ and ‘second’ are merely being used as labels, and the first comparison circuitry does not need to be provided at the very first level of a comparison tree. The first set of comparison values could be input data values, or could be results of a higher level of comparison.

As mentioned above, the first comparison circuitry can provide at least one portion of the first result to the second comparison circuitry before the full first result is known. This can enable the second comparison circuitry to begin performing the second comparison operation, which uses the first result, before the first comparison operation has finished (as long as required portions of the other values in the second set of comparison values, e.g., the further comparison value, are also available to the second comparison circuitry). It will be appreciated that the second comparison operation cannot be completed until the full first result has been provided, but that each portion of the second result value can be determined when a corresponding portion of each of the second set of comparison values is available. Therefore, the second comparison circuitry and the first comparison circuitry may be configured to perform the second comparison operation and the first comparison operation concurrently, and by doing so can allow the second result to be determined sooner than alternative approaches which, for example, require the full first result to be determined before the second comparison can begin.

Each of the first and second set of comparison values and first and second results may have the same size, with portions defined in the same way for each value (meaning that portions can be mapped one-to-one between values).

To determine a given portion of the second result, the second comparison circuitry may require a corresponding portion of each of the second set of comparison values to be available. For example, to determine the most significant portion of the second result, the most significant portion of each of the second set of comparison values (including the first result) is required. Therefore, the second comparison circuitry is unable to determine the most significant portion of the second result at the same time that the first comparison circuitry is determining the most significant portion of the first result. However, the second comparison circuitry can determine the most significant portion of the second result at the same time that the first comparison circuitry is determining a less significant portion of the first result, having already determined the most significant portion of the first result and provided it to the second comparison circuitry. That is, the second comparison circuitry and the first comparison circuitry may be configured to perform a more significant portion of the second comparison operation and a less significant portion of the first comparison operation concurrently.

As mentioned above, the target extreme value of the first set of comparison values and the target extreme value of the second set of comparison values may be either a maximum or a minimum. Both the maximum and minimum can be determined in similar ways in portion-wise operations starting with the most significant portion, as discussed in greater detail below.

As discussed above, the first and second comparison circuitry may be provided within adjacent levels of a tree of comparators. In some examples, the tree may include a similarly configured third level after the second comparison circuitry. In particular, the apparatus may comprise third comparison circuitry configured to perform a third comparison operation to determine a third result representing the target extreme value of a third set of comparison values comprising the second result and at least one further comparison value, the third comparison operation comprising determining portions of the third result in reducing order of significance starting from a most significant portion of the third result.

Similar to the relationship between the first comparison circuitry and the second comparison circuitry, the second comparison circuitry may be configured to provide portions of the second result to the third comparison circuitry independent of whether a less significant portion of the second result has been determined. Additionally, the third comparison circuitry may be configured to determine a given portion of the third result when a corresponding portion of each of the third set of comparison values (including the second result) has been made available to the third comparison circuitry, independent of whether less significant portions of each of the third set of comparison values have been made available to the third comparison circuitry. Therefore, a more significant portion of the third comparison operation may be performed concurrently with a less significant portion of the second comparison operation. By providing additional levels of comparison circuitry, a greater number of input values can be compared to determine the overall extreme value. In an example providing three levels of comparison, the performance advantages compared to the use of subtraction (or other approaches requiring a full intermediate result to be determined before the subsequent level of comparison can begin) may be even more significant. In particular, not only may the third comparison operation be overlapped with the second comparison operation, the third comparison operation may also be overlapped with the first comparison operation, resulting in a significant performance improvement.

It will be appreciated that further levels of comparison circuitry may be included, configured in a similar way to enable concurrent performance of a comparison operation with performance of earlier comparison operations. Each additional level of comparison circuitry may only add the time taken to perform one portion of comparison to the overall time taken to perform the operation.

In some examples, the at least one further comparison value provided to the second comparison circuitry (and, where appropriate, the third or further comparison circuitry) may be a new input value which is not the result of a previous comparison operation. However, in some examples the apparatus may comprise further comparison circuitry configured to perform a further comparison operation to determine a further result representing a target extreme value of a further set of comparison values, the further comparison operation comprising determining portions of the further result in reducing order of significance starting from a most significant portion of the further result, wherein the second set of comparison values comprises the first result and the further result (i.e., at least one further comparison value in the second set of comparison values is a result of a comparison operation). The further comparison circuitry may be configured similarly to the first comparison circuitry, and the further comparison circuitry may be configured to provide a portion of the further result to the second comparison circuitry independent of whether a less significant portion of the further result has been determined. Corresponding portions of the first comparison operation and further comparison operation may be performed concurrently, and both may be performed concurrently with a more significant portion of the second comparison operation.

In some examples, at least one of the first set of comparison values and the second set of comparison values consists of two values. Therefore, the first comparison circuitry may compare two values and the second comparison circuitry may compare two values (represented by the first result and one further comparison value). A comparison between two values may be computationally straightforward, meaning that each portion of each result can be computed with a small delay. As discussed above, the delay of each additional level of comparison may be the time for each portion to be computed, so minimising the time for the comparison of a portion can improve overall performance of the comparator.

The portion size is not particularly limited. In some examples, the portion size is one bit. Therefore, the first and second comparison circuitry may each perform bitwise comparisons, and the first comparison circuitry may provide the first result to the second comparison circuitry one bit at a time. The second comparison operation may therefore begin as soon as the first bit of the first result has been determined. As mentioned above, the delay of each additional level of comparison may be the time for each portion to be computed, so minimising the time for the comparison of a portion can improve overall performance of the comparator. A single bit is the smallest possible portion size and therefore providing a portion having the size of a single bit may be associated with the smallest offset between the first and second comparison operations, and hence the best overall performance.

The first result represents the target extreme value of the first set of comparison values. In some examples, the first result may simply be equal to the target extreme value. However, in other examples one or more predetermined portions of the first result may differ from (e.g., may be the inverse of) the respective portions of the target extreme value. The inventors have realised that certain implementations of circuitry for determining each portion of the extreme value of the first set of comparison values may provide the inverse of certain portions of the extreme value of the first set of comparison values. Similarly, certain implementations of circuitry for performing the second comparison operation may require the inverse of certain portions of one of the second set of comparison values (which includes the target extreme value of the first set of comparison values). Although one approach would be to implement inversion circuitry in the first comparison circuitry for relevant portions, such that the first result is equal to the target extreme value of the first set of comparison values, and then implementing further inversion circuitry in the second comparison circuitry to invert relevant portions to perform the second comparison operation, the inventors have realised that unnecessary inversions can be avoided by propagating the inverse of certain predetermined portions of the first result between the first comparison circuitry and second comparison circuitry. Therefore, in some examples, at least one predetermined portion of the first result comprises an inverse of the corresponding portion of the target extreme value of the first set of comparison values. The second set of comparison values may include the target extreme value of the first set of comparison values, as represented by the first result. This can improve performance and reduce unnecessary power and area cost by avoiding the need to provide redundant pairs of inversion circuitry in the first comparison circuitry and the second comparison circuitry.

Similar considerations apply when using further levels of comparison circuitry. For example, predetermined portions of the second result may be equal to the inverse of the target extreme value of the second set of comparison values. Similarly, predetermined portions of the at least one further comparison value input to the second comparison circuitry may be inverted with respect to the value represented by the further comparison value.

The first and second comparison operations described herein may be applied in a straightforward manner to unsigned integers, for which working in decreasing order of significance from the most significant portion allows portions of the larger (or smaller) value to be identified. The present techniques may also be applied to two's complement values. A two's complement value may represent a signed integer, and the most significant bit of a two's complement value may be a sign bit indicating whether the integer is positive or negative. A two's complement value having the sign bit equal to 1 may represent a negative integer, and a two's complement value having the sign bit equal to 0 may represent a positive integer. For positive integers, the two's complement representation of the integer may be the same as an unsigned integer representation. The negative two's complement representation of an integer can be obtained by inverting all the bits of the integer and then adding 1 to the result, meaning that the non-sign bits of negative values closer to zero represent a larger integer than the non-sign bits of negative values further from zero. For example, a four bit two's complement representation of-1 may be 1111, and −2 may be 1110. The inventors have realised that the format of a two's complement value lends itself to similar comparison as an unsigned integer, for both positive and negative values. In particular, for negative values the bits of a larger two's complement value (closer to zero, i.e., having a smaller magnitude) represent a larger value if treated as an integer than the bits of a smaller value (i.e., a negative value having a larger magnitude). For instance, −1 is represented as 1111 and −2 is represented as 1110. −1 is larger than −2, and this result would be correctly obtained by comparing 1111 and 1110. Hence, among negative values and among positive values the comparison can be performed as if the two's complement value were an integer. However, the result would be incorrect if comparing a positive value with a negative value, as all negative values (which are by definition smaller than positive values) have the most significant bit equal to 1, and hence if treated as an integer would be considered larger than all positive values which have the most significant bit equal to 0.

Therefore, to support comparison of two's complement values, the apparatus may comprise comparison value signing circuitry configured to add an extension bit to the most significant side of each of a set of input two's complement values to provide the first set of comparison values. The extension bit for a given input two's complement value is the inverse of a sign bit of the given two's complement value, e.g., the inverse of the most significant bit of the two's complement value. Therefore, whilst positive two's complement values start with 0 and negative two's complement values start with 1, positive values in the first set of comparison values may start with 1 and negative values may start with 0 (with the other bits then remaining unchanged), so that a comparison between a positive value and a negative value yields the correct result that the positive value is larger than the negative value.

It will be appreciated that, whilst the above discussion refers to bits having the value 0 or 1, the notation could be inverted without loss of meaning.

Many different approaches could be used for implementing the first comparison operation to allow the first result to be generated portion-wise in decreasing order of significance by providing different arrangements of the first comparison circuitry. In general, for each portion of the first set of comparison values, either: that portion is the same for the comparison values, or that portion differs between comparison values. When working from the most significant portion, for as long as a current portion and all previous portions are equal, the current portion of the first result can be taken from any of the comparison values (which are all the same). When a portion is reached that differs between the comparison values, then one of the comparison values can be identified as the extreme data value. From that point onwards, each portion of the first result should be taken from the extreme data value, and therefore some history mechanism may be used to track whether any, and if so which, of the first set of comparison values has been determined in a previous portion to be the extreme data value, allowing subsequent portions of the first result to be selected appropriately. In some examples, the first comparison operation comprises generating a set of history values, each history value corresponding to each of the first set of comparison values, and each history value identifying whether the corresponding comparison value is the target extreme value of the first set of comparison values. Hence, a history value can be provided for each comparison value, tracking whether that comparison value is the extreme data value. The history values can be referenced during subsequent portions of the first comparison operation to determine whether any previous stage of the first comparison operation has identified any of the comparison values as the extreme data value. For instance, for a given portion of the first comparison operation, the first comparison circuitry may determine whether any of the history values are set to indicate that the corresponding comparison value is the extreme data value, and if so select the given portion of that comparison value as the given portion of the first result. The provision of history values can provide a particularly efficient circuit implementation of the first comparison operation.

In some examples, the history values may have the same size as the comparison values and may be similarly considered as separate portions (e.g., bits). For a given portion of a given history value, when more significant portions of the first set of comparison values are not equal, the given portion of the given history value may indicate whether the corresponding comparison value is the target extreme value of the first set of comparison values. Hence, when more significant portions of the first set of comparison values are not equal (and therefore an extreme data value has been identified among the first set of comparison values) the given portion of the history values can be used to select the given portion of the first result. If the more significant portions of the first set of comparison values are equal then none of the values has yet been identified as the extreme data value (this can be identified from the history values all being equal) and therefore the given portion of the first result should be selected based on comparing the given portion of the first set of comparison values.

In some examples, the first comparison circuitry may be configured to set each portion of the given history value to one of a first state (a ‘killed’ state) indicating that the corresponding comparison value is not the target extreme value and a second state (indicating that the corresponding comparison value may be the target extreme value). The first and second state may be represented by the bits 1 and 0. The first comparison circuitry may be configured to set a given portion of a given history value to the first state (indicating that a given comparison value corresponding to the given history value is not the target extreme value) in response to determining either:
an adjacent more significant portion of all of the set of history values is set to the second state and the given portion of one of the first set of comparison values which does not correspond to the given history value has the target extreme value among corresponding portions of the first set of comparison values; or
a more significant portion of the given history value is set to the first state.

In the first case, all earlier (more significant) portions of the first set of comparison values are equal. For the given portion, the comparison values differ and therefore an extreme value can be identified. If the given portion of another comparison value (not corresponding to the given history value) has the extreme value, then that other comparison value is the extreme data value and the given history value should be set to the first state to indicate that a given comparison value corresponding to the given history value is not the target extreme value. In the second case, it has already been determined at a more significant portion that the comparison value corresponding to the given history value is not the extreme data value (i.e., the first case has already happened) and the second state is merely propagated to a later portion of the given history value. If neither of the first or second cases is true, then the given portion of the history value is set to the second state.

When implementing portion-wise history values as described above, a given portion of the first comparison operation may depend solely on the given portion of the first set of comparison values and an adjacent more significant portion of the set of history values (if available). That is, the first comparison circuitry may be configured to determine a given portion of the first result based on the given portion of the first set of comparison values and an adjacent more significant portion of the set of history values. This can enable a particularly efficient circuit implementation, as signals do not need to be propagated over long distances, resulting in area and power savings. For example, the outcome of a comparison between much earlier portions of a comparison values does not need to be known and hence signals do not need to be propagated from significantly earlier portions of the history values or the comparison values. Signals only need to be propagated from, at maximum, the adjacent portion of the history and comparison values.

Whilst the above discussion focusses on the first comparison operation for generating the first result value, the same approach could be used for the second comparison operation for generating the second result value. History values may be generated in a similar way and used to assist portion-wise comparison of the second set of comparison values. It will be appreciated that similar approaches could be used in any set of comparison circuitry used to perform a comparison operation in such an apparatus.

In some examples, the first comparison circuitry and the second comparison circuitry may form adjacent nodes in a binary tree of 2-input comparators. Hence, the first and second sets of comparison values may include pairs of comparison values, and the further comparison value may also be provided as the outcome of a comparison of two values. As discussed above, the present techniques allow additional levels to be added to a binary tree of comparators (each time doubling the total number of values which can be compared) with a minimal cost to timing, and can hence allow large numbers of values to be compared in a short period of time.

Examples will now be discussed with reference to the Figures.

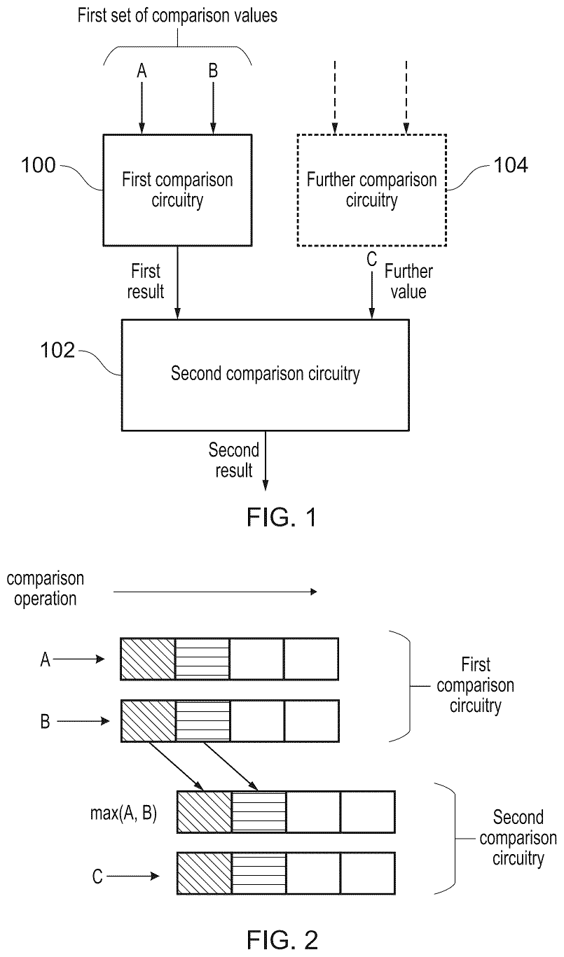

FIG. 1 schematically illustrates first comparison circuitry 100 and second comparison circuitry 102. The first comparison circuitry 100 takes as inputs a first set of comparison values, shown as the pair of values A and B in FIG. 1. The first comparison circuitry outputs a first result, representing the maximum or minimum (as the case may be) of the inputs A and B, to the second comparison circuitry 102. The second comparison circuitry receives the first result and one or more further comparison values as inputs. In FIG. 1, the inputs are shown as the first result and the further value C. The second comparison circuitry outputs a second result, representing the maximum or minimum of the first result and C, and hence representing the max/min of A, B, and C.

The first comparison circuitry 100 and second comparison circuitry 102 occupy adjacent levels within a tree of comparators. The values A and B may be provided from earlier comparison circuitry, or one or both could be new inputs. Similarly, the value C could be a new input or could be provided as the result of earlier comparison circuitry 104 (which itself takes two or more inputs). The second result may represent the final result of the tree of comparators, or could be provided as one of the inputs into a further instance of comparison circuitry. In any case, for the purposes of illustrating the present techniques, as shown in FIG. 1 the first comparison circuitry 100 and second comparison circuitry 102 determine the max/min of the input values A, B, and C over two subsequent comparison operations.

In an alternative technique, the first comparison circuitry 100 and the second comparison circuitry 102 may be provided by adder circuits arranged to perform a subtraction between the inputs. The carry out signal of the subtraction indicates which input is larger, and can therefore be used to select the output. For example, when determining the maximum of the two unsigned values A and B, the operation A-B may be performed, and if cout==1 then A>=B (and A is selected as the first result) and if cout==0 then A<B (and B is selected as the first result). However, the subtraction operation must fully complete before the carry out signal can be examined and the outcome determined for providing to the next step. If using subtraction, the time taken to determine max(A, B, C) will include the time taken to perform two subtraction operations (A-B, and then max(A, B)-C) one after another. As further levels of comparison are added, the time taken to perform the overall comparison increases by the full subtraction operation for each additional level.

However, the present technique allows performance to be improved significantly and allows such comparisons to be completed more quickly than the alternative approach. According to the present technique, for each of the first and second comparison operations performed by the first comparison circuitry 100 and the second comparison circuitry 102, each portion (e.g. bit) of each input is considered in decreasing order of significance starting from a most significant portion.

A given portion of the max/min of a set of values can be determined based on knowing only that portion and any more significant portions of the set of values. It is not necessary to know what the less significant bits are of each input value to know what the more significant bits will be. This does not work the other way around-from looking only at the less significant bits of the inputs the less significant bits of the max/min cannot be determined (because which of the inputs is the maximum/minimum, from which the less significant bits should be selected, is dictated by the more significant bits of the inputs). For instance, consider A=0100 and B=0011, of which A is the larger value (i.e., max(A, B)=0100). Starting from the most significant bit, it can be determined that max(A, B)[3]=0, because both A and B have the MSB 0. Considering the next bit, it can be determined that A is the larger value and therefore that max(A, B)[2]=1. However, starting from the least significant bit, it cannot be determined from A[0]=0 and B[0]=1 whether max(A, B)[0] is 1 or 0, because from merely looking at the LSB it is not known which of A or B is larger.

When performing comparison operations in reducing order of significance starting from the most significant portion, two things are true:
a portion of the result can be provided without yet knowing the value of the less significant portions of the result, and
the operation can begin once respective portions of the inputs are known, without waiting for the full inputs
   These two observations allow comparison operations at the first comparison circuitry 100 and the second comparison circuitry 102 to be performed concurrently, as illustrated in FIG. 2.

FIG. 2 schematically illustrates comparison operations performed on input values A, B, and C to identify the maximum of the input values (in another example, a minimum could be similarly identified). Each of the input values is divided into four portions (e.g., values A, B, and C could be 4-bit values, with each portion equal to a bit), where each portion is numbered from the least significant portion (e.g., the most significant portion is [3] and the least significant portion is [0]). The input values A, B, and C are shown in order having a most significant portion at the left and a least significant portion at the right.

The first comparison circuitry 100 performs a first comparison operation on values A and B in reducing order of significance from the most significant portion, as indicated by the arrow at the top of FIG. 2 indicating the order of the comparison operations. As each portion of the result max(A, B) becomes available, it is provided to the second comparison circuitry 102, which also receives input value C.

The second comparison operation can determine each portion of max(A, B, C) once the corresponding portions of max(A, B) and C have been received, and therefore can begin determining the most significant portion of max(A, B, C) once the most significant portions of max(A, B) and C have been provided. Hence, the second comparison circuitry 102 can calculate max(A, B, C)[3] at the same time that the first comparison circuitry 100 is calculating max(A, B)[2], and max(A, B, C)[2] at the same time that the first comparison circuitry is calculating max(A, B)[1], and so on.

As shown in FIG. 2, each additional level of comparison only adds the delay of one portion of a comparison operation (e.g., the offset between the first comparison circuitry and the second comparison circuitry is the length of one portion of comparison). As discussed in greater detail below, this may be a short delay (e.g., one complex gate and one 2-input mux), meaning that the time taken to perform an additional level of comparisons only slightly increases the overall computation time. Therefore, whilst the first comparison operation and the second comparison operation might appear individually slow (e.g., compared to subtraction), their ability to be overlapped (and overlapped with subsequent or preceding levels of comparison) allows performance for the overall comparison of three or more input values to be performed much faster than simply combining separate, individually faster, operations at each instance of the comparison circuitry.

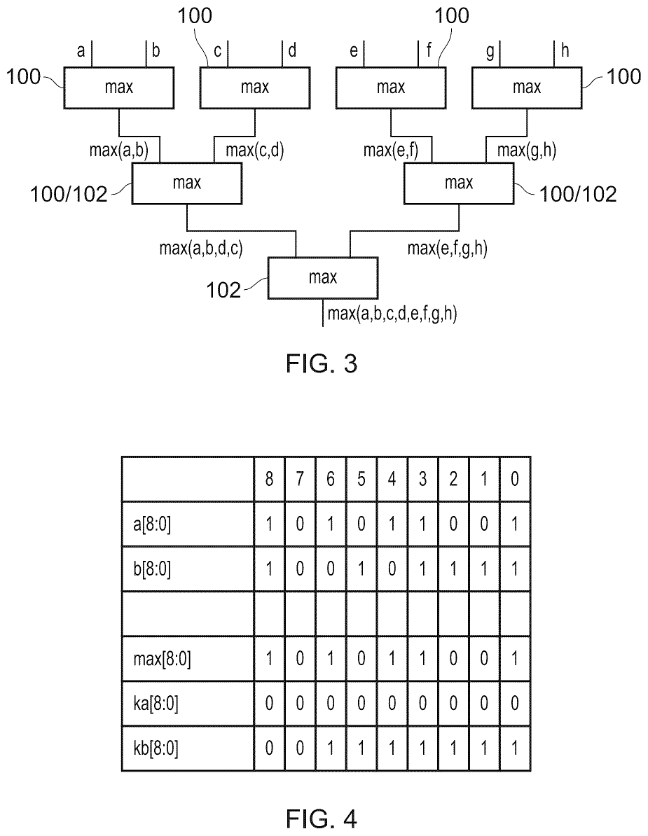

FIG. 3 schematically illustrates a 3-level binary tree of 2-input comparators. The tree of FIG. 3 is arranged to calculate the maximum of 8 inputs. A first level of the tree includes four instances of comparison circuitry configured to determine the maximum of each of four pairs of the eight inputs. A second level of the tree includes two instances of comparison circuitry configured to determine the maximum of each of two pairs of the four results of the first level, and a third level of the tree includes one instance of comparison circuitry configured to determine the maximum of the pair of two results of the second level to determine the overall maximum of the eight inputs.

Each adjacent pair of comparison circuitry shown in FIG. 3 forms a pair of first comparison circuitry 100 and second comparison circuitry 102 as illustrated in FIG. 1. For example, the comparison circuitry for determining max(c, d) is an example of the first comparison circuitry 100 for which the second comparison circuitry 102 is the comparison circuitry for determining max(a, b, c, d). The comparison circuitry for determining max(a, b, c, d) is also an example of the first comparison circuitry 100 for which the second comparison circuitry 102 is the comparison circuitry for determining max(a, b, c, d, e, f, g, h) (in this case, the comparison circuitry for determining max(c, d) could be referred to as first comparison circuitry, the comparison circuitry for determining max(a, b, c, d) could be referred to as second comparison circuitry, and the comparison circuitry for determining (a, b, c, d, e, f, g, h) could be referred to as third comparison circuitry for ease of reference).

The delay between the start of the operation and the first level of comparison circuitry providing the first portion of its results to the second level of comparison circuitry is equal to the time taken to perform one portion of comparison. Similarly, the delay between the first level of comparison circuitry providing the first portion of its result to the second level of comparison circuitry and second level of comparison circuitry providing the first portion of its result to the third level of comparison circuitry is equal to the time taken to perform one portion of comparison. Therefore, the time taken for the third level to finish its comparison operation (completing the overall comparison) is only two portions of comparison (e.g., the time taken to perform a comparison for a single bit) longer than the time taken for the first level to finish its comparison operation. This trend continues as additional levels of comparison are added. To compare 16 inputs, a further level of comparison is added (e.g., the tree shown in FIG. 3 is duplicated and each input is provided to a single further instance of comparison circuitry). Therefore, the time taken to compare 16 inputs is only one portion (one bit of comparison) more than the time taken to compare 8 inputs, the time taken to compare 32 inputs is only one portion of comparison more than the time taken to compare 16 inputs, and so on. The seemingly slow method of portion-wise comparison for finding the maximum of two values becomes much faster than the usual method (subtraction) when computing the maximum of more than two values, e.g., 8, 16, 32 or more values. In some implementations, determining the maximum of 32 values using this approach can easily fit within a single CPU clock cycle.

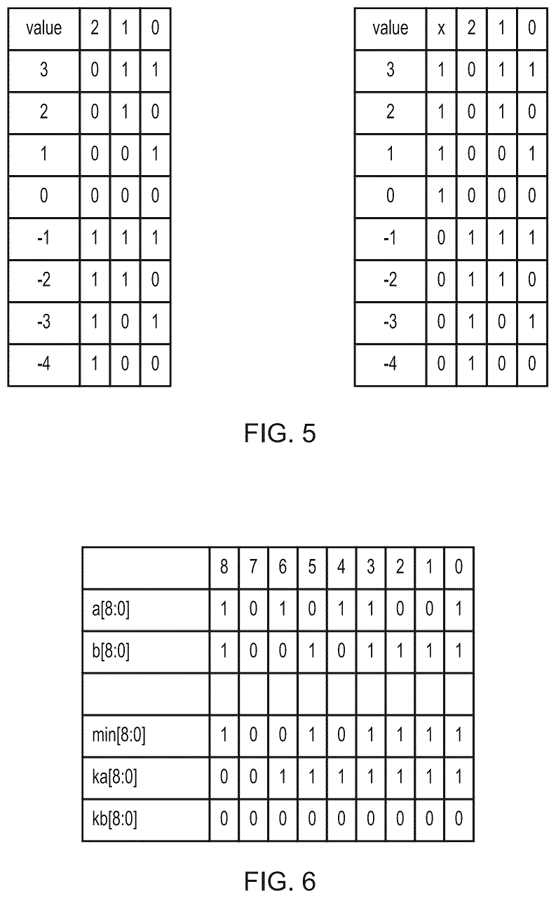

FIG. 4 schematically illustrates an approach to perform a bitwise (a bit being an example of a portion) comparison operation to compare two 9-bit inputs a[8:0] and b[8:0] to determine the maximum value max[8:0], determining each bit of max[8:0] in decreasing order of bit significance. This approach may be used in the first comparison circuitry 100 and second comparison circuitry 102 discussed with reference to FIG. 1, and for example could be used in each instance of comparison circuitry shown in FIG. 3.

Two additional values are maintained internally within the comparison circuitry to perform the comparison operation. These values are ka[8:0] and kb[8:0], which are history values (or kill values) corresponding to the inputs a[8:0] and b[8:0] respectively.

The comparison proceeds one bit at a time from the most significant bit to the least significant bit, and therefore from left to right of FIG. 4. Once a bit is reached that allows a maximum value to be determined, the corresponding bit of the history value corresponding to the non-maximum value is set (to ‘kill’ that input), allowing subsequent bits of max[8:0] to be selected from the non-killed input.

In the example shown in FIG. 4, this proceeds as follows:
For the most significant bit, both a[8] and b[8] are 1, so max[8]=1 and neither a nor b are killed (ka[8]=0, kb[8]=0). At this point max[8] can be output to a subsequent level of comparison to allow a subsequent comparison operation to begin.
For the next bit, neither a nor b have been killed and a[7] and b[7] are both 0, so max[7]=0 and neither a nor b are killed (ka[7]=0, kb[7]=0). Max[7] can be output.
For the next bit, neither a nor b have been killed and a[6]=1 and b[6]=0, so max[6]=1 (and can be output). At this point, we know that a[8:0] is larger than b[8:0] and therefore that max[8:0]=a[8:0]. For all subsequent bits, max[N] can be taken from a[N]. This is indicated by killing the input b, by setting ka[6]=0 and kb[6]=1.
For the next bit, b is killed and therefore max[5]=a[5], and max[5] can be output. This repeats for all remaining bits, i.e., max[5:0]=a[5:0].

This approach can be represented by the following logic for computing the max and kill signals:

max[N]=(~ka[N+1] & a[N])|(~kb[N+1] & b[N]) (1)

ka[N]=ka[N+1]|(max[N] & ~a[N]) (2)

kb[N]=kb[N+1]|(max[N] & ~b[n]) (3)

In which | represents the logical OR operation, ~ represents inversion operation, and & represents the logical AND operation. For the most significant bit, ka[N+1] and kb[N+1] (i.e., ka[9] and kb[9]) do not exist, and can be considered equal to zero.

The logic for calculating each bit of the maximum value can be explained as follows. If either input has been killed then the adjacent more significant bit of one of the kill signals (e.g., ka[N+1]) will have the value 1, and therefore the inverse (e.g., ~ka[N+1]) will have the value 0. Each input is combined with the inverse of the kill signal, meaning that the max[N] cannot be taken from a killed input. For instance, if ka[N+1]=1, then (~ka[N+1] & a[N])must be 0. If ka[N+1]=1 then kb[N+1]=0 (only one input can be killed), and therefore (~kb[N+1] & b[N])=b[N], so max[N]=b[N] when a is killed (and vice versa). If neither input is killed, then ka[N+1] and kb[N+1] both equal 0, ~ka[N+1] and ~kb[N+1] both equal 1, and the above equation can be simplified to max[N]=a[N]|b[N], meaning that the Nth bit of max(a, b) is simply the largest one of the Nth bit of a and the Nth bit of b. The below equations (4) to (6) show equation (1) simplified for different values of the kill signals.

{if ka[N+1]=1, kb[N+1]=0} max[N]=b[N] (4)

{if ka[N+1]=0, kb[N+1]=1} max[N]=a[N] (5)

{if ka[N+1]=0, kb[N+1]=0} max[N]=a[N]|b[N] (6)

The logic for calculating the kill signals can be explained as follows. Once a kill signal is set, it should be propagated to all subsequent bits of the comparison. Therefore, if the adjacent more significant bit is set to 1, then the current bit should also be set to 1. Hence, if ka[N+1]=1 then ka[N]=1. If the adjacent more significant bit is not set to 1, then the corresponding input has not been killed in any previous bits of comparison. However, the input should be killed for subsequent bits of comparison if the current bit of comparison identifies that the input is not the maximum. For setting ka[N], this can be determined by comparing max[N] with a[N]. If max[N] is not the same as a[N] then a[8:0] is not the maximum and ka[N] should be set to 1 to kill the input a[8:0]. Hence, when ka[N+1]=0, ka[N]=max[N] & ~a[N] which equals 1 when max[N] differs from a[N] and zero otherwise. The same approach is used for computing kb[N].

It will be appreciated that the example given above is merely one example implementation of the comparison operation, and variations on this approach may be used.

It will be seen that the logic for calculating each bit of max[8:0] (i.e., the operation for calculating max[N]) incurs a delay of one 2-input mux and one complex (AO) gate. The total delay for calculating max[8:0] is 9 times this delay, which may not be competitive with subtraction. However, as discussed above, due to the overlapping of operations in subsequent levels, for each additional level of comparison (e.g., each time the number of input values doubles) the total delay only increases by one 2-input mux and one complex (AO) gate, meaning that the delay to compute the maximum of 4 values is only one complex gate and one mux more than the delay to compute the maximum of 2 values. Similarly the delay to compute the maximum of 8 values is only one complex gate and one mux more than the delay to compute the maximum of 4 values, and so on as discussed above resulting in high performance for multi-level comparisons. Additionally, the simple logic (one mux and one complex gate per bit) used for the bitwise comparison means that this technique can compare numerous values with a reduced power cost (compared to the use of adders).

Equations (1)-(3) above include both inverted and non-inverted versions of a, b, ka, and kb. Whilst each step could include logic to invert the relevant inputs for that step, there can be more efficient implementations which avoid repeated inversion operations in a multi-level tree where the outputs from a previous level are used as inputs for the next level. For example, equations (1)-(3) can be rearranged to provide the following equations:

max[N]=~((ka[N+1]|~a[N])&(kb[N+1]|~b[N])) (7)

~max[N]=~((~ka[N+1]&a[N])|(~kb[N+1]&b[N])) (8)

~ka[N]=~(ka[N+1]|(~kb[N+1]&b[N]&~a[N])) (9)

kb[N]=~(~kb[N+1]&(ka[N+1]|~a[N]|b[N])) (10)

It will be seen that ~max[N] can be calculated from a[N] and b[N] and max[N] can be calculated from ~a[N] and ~b[N]. In one approach, the inputs a[N] and b[N] could be used as provided, resulting in the value ~max[N]. The value could then be inverted to provide the output max[N] which can be used as input in the subsequent level. However, at the subsequent level the result would once again be ~max[N]. For example, if the inputs a[N] and b[N] were used in a comparison in a first level to calculate ~max(a, b)[N] and the output inverted to provide max(a, b) [N], a further comparator similarly determines max(c, d)[N], and the values max(a, b)[N] and max(c, d)[N] were then provided to the next level as inputs to a comparison, then the result would be ~max(a, b, c, d)[N], which would again need to be inverted to provide max(a, b, c, d)[N]. However, if the outputs of the first level were not inverted (and therefore remained ~max(a, b)[N] and ~max(c, d)[N]), then the inputs to the second level would be ~max(a, b)[N] and ~max(c, d)[N], and it will be seen that the result would be max(a, b, c, d)[N] (rather than ~max(a, b, c, d)[N], which would be the case if max(a, b)[N] and max(c, d)[N] were used as the inputs). Hence, rather than performing unnecessary inversions on all outputs of each instance of comparison circuitry, certain bits of the result max[N] can be output in their inverted form, and the inversions can sort themselves out over several stages of comparison. This means that the output from a certain level of comparator may include bits which are inverted with respect to the maximum or minimum of the inputs to that level (e.g., may include certain bits which are ~max[N]), reducing an overall number of inversion operations which may be performed.

It will also be seen that at each stage, the same set of inputs ka[N+1] and ~kb[N+1] can be used to create both further kill values ~ka[N] and kb[N], but that these values are inverted with respect to each other. To reduce internal inversion operations, inverted versions of the kill values may be propagated between bits of the comparison operation.

A more efficient implementation may be achieved (e.g., to reduce inversion operations on the input and kill values used to calculate each max bit) by alternating, for bits of the output of each set of comparison circuitry, whether the output is inverted or not inverted. To increase the degree to which inversion can be reduced, two inputs to a comparison may therefore be provided with bits inverted with respect to each other in an alternating pattern. For instance, comparison circuitry may receive inputs max(a, b)[6] and ~max(c, d)[6], then ~max(a, b)[5] and max(c, d)[5], then max(a, b)[4] and ~max(c, d)[4], and so on.

The approach described with reference to FIG. 4 can be used to identify the maximum of a set of integers. FIG. 5 illustrates how the approach described above can also be used for two's complement values. The left side of FIG. 5 shows example 3-bit two's complement values. An unsigned representation of a positive integer is the same as its two's complement representation. To obtain the two's complement representation of a given negative integer, each bit of a positive integer having the same size as the negative integer can be inverted, with 1 added to the result. For instance, to obtain the 3-bit two's complement representation of −3, start with 3 which is 011, invert to get 100, and add 1 to get 101. Using this approach, it will be seen that negative values can be compared with each other as if they were integers and the outcome is correct. For instance, comparing −2 and −4, 110 is a larger integer than 100, and therefore the correct result that −2 is larger than −4 is obtained. However, The first bit of negative two's complement numbers is 1 and the first bit of positive two's complement numbers is 0, meaning that positive and negative values cannot be correctly compared with each other (or the outcome would incorrectly indicate that the negative value is larger than the positive value).

However, according to the present technique, an additional extension bit can be added to the most significant side of the two's complement numbers, being an inverted version of the sign bit. This is shown on the right hand side of FIG. 5, and results in all positive values starting with the two bits 10 and all negative values starting with the two bits 01, and therefore allowing positive and negative values to be compared correctly with the positive value being larger than the negative value. The added “x” bit can then be dropped when returning the final result of the comparison (e.g., after all the levels of comparison circuitry), as it was only included to be used during the comparison operations and does not form part of the result value.

In an alternative approach to the approach shown in FIG. 5, signing circuitry could instead invert the most significant bit of the inputs (making the MSB have the value of the “x” bit discussed above), rather than adding the inverted bit to the most significant side of each input. It will be appreciated that, for the same reasons given above, this will result in the correct result when comparing negative and positive two's complement values as if they were integers. Unsigning circuitry could then invert the most significant bit of the result value before it is output.

Whilst FIG. 4 shows an operation to determine the maximum value of two inputs, similar techniques can be used to determine the minimum value. FIG. 6 schematically illustrates an approach to perform a bitwise comparison operation to compare two 9-bit inputs a[8:0] and b[8:0] to determine the minimum value min[8:0]. The logic for determining the minimum value is similar to the logic for determining the maximum value, as follows

min[N]=(ka[n+1]&b[n])|(kb[n+1]&a[n])|(a[n]&b[n]) (11)

ka[N]=ka[N+1]|(~min[N] & a[N]) (12)

kb[N]=kb[N+1]|(~min[N] & b[N]) (13)

The logic for calculating each bit of the minimum value can be explained as follows. If either input has been killed then the adjacent more significant bit of one of the kill signals (e.g., ka[N+1]) will have the value 1, and therefore the minimum is provided by the other input. If neither kill signal is set, the output is provided by the AND of the two inputs, so the minimum is only 1 if both inputs are 1. The logic for calculating the kill signals corresponds to the kill signals used in the maximum calculation as described above. Once a kill signal is set, it should be propagated to all subsequent bits of the comparison. Hence, if ka[N+1]=1 then ka[N]=1. If the adjacent more significant bit is not set to 1, then the corresponding input has not been killed in any previous bits of comparison. However, the input should be killed for subsequent bits of comparison if the current bit of comparison identifies that the input is not the minimum. For setting ka[N], this can be determined by comparing min[N] with a[N]. If min[N] is not the same as a[N] then a[8:0] is not the minimum and ka[N] should be set to 1 to kill the input a[8:0]. Hence, when ka[N+1]=0, ka[N]=~min[N] & a[N] which equals 1 when min[N] differs from a[N] and zero otherwise. The same approach is used for computing kb[N].

In the example shown in FIG. 6, this proceeds as follows:
For the most significant bit, both a[8] and b[8] are 1, so min[8]=1 and neither a nor b are killed (ka[8]=0, kb[8]=0). At this point min[8] can be output to a subsequent level of comparison to allow a subsequent comparison operation to begin.
For the next bit, neither a nor b have been killed and a[7] and b[7] are both 0, so min[7]=0 and neither a nor b are killed (ka[7]=0, kb[7]=0). Min[7] can be output.
For the next bit, neither a nor b have been killed and a[6]=1 and b[6]=0, so min[6]=0 (and can be output). At this point, we know that a[8:0] is larger than b[8:0] and therefore that min[8:0]=b[8:0]. For all subsequent bits, min[N] can be taken from b[N]. This is indicated by killing the input a, by setting ka[6]=1 and kb[6]=0.
For the next bit, a is killed (ka[6]=1) and therefore min[5]=b[5], and min[5] can be output to the next level. This repeats for all remaining bits, i.e., min[5:0]=b[5:0].

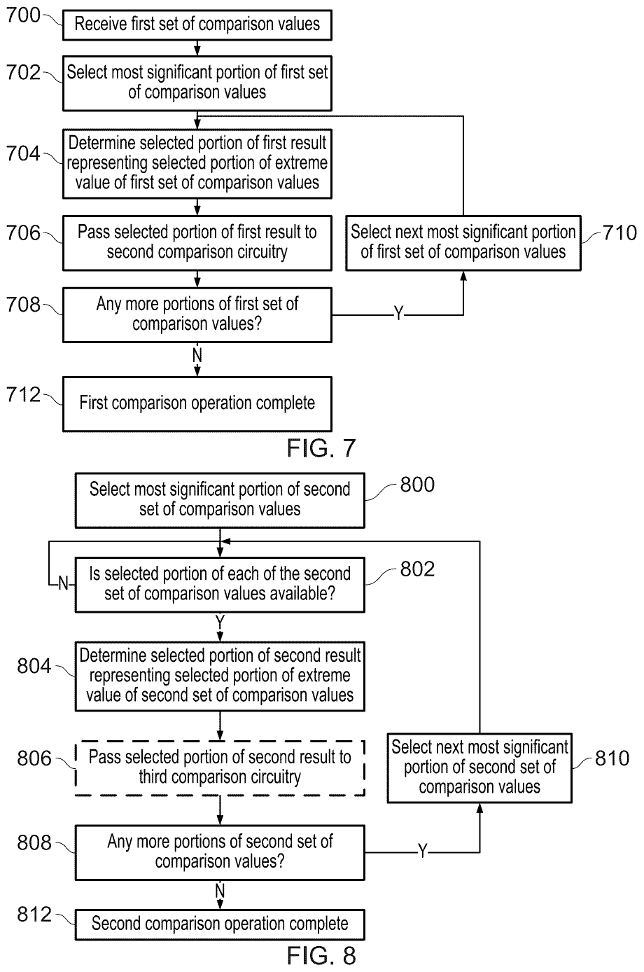

FIG. 7 is a flow diagram schematically illustrating a method for performing a first comparison operation to determine an extreme data value of a first set of comparison values. At step 700, the first comparison circuitry 100 receives a first set of comparison values. In some examples, these values may be received portion by portion (e.g., as shown in FIG. 8), although this is not essential.

At step 702, the first comparison circuitry starts by selecting the most significant portion of each of the first set of comparison values (e.g., the most significant bit MSB).

At step 704, the first comparison circuitry determines the selected portion of the first result representing the extreme value (maximum or minimum) of the first set of comparison values. This step may use the selected portion and an adjacent more significant portion of each of the first set of comparison values (and may also use history values) as described with reference to FIGS. 4 and 6. At step 706, the selected portion of the first result is output to second comparison circuitry (to enable the second comparison circuitry to begin a second comparison operation with the first result as an input).

At step 708 it is determined whether there are any remaining portions of the first set of comparison values. If so, then at step 710 the next most significant portion of the first set of comparison values is selected (e.g., if portion [8] was previously selected, then select portion [7]) for the next level of comparison and the process returns to step 704. If there are no remaining portions of the first set of comparison values, then the first comparison operation is complete at step 712.

FIG. 8 is a flow diagram schematically illustrating a method for performing a second comparison operation to determine an extreme data value of a second set of comparison values.

At step 800, the second comparison circuitry selects the most significant portion of the second set of comparison values. At step 802, the second comparison circuitry determines whether it has received the selected portion of each of the second set of comparison values. If not, the process remains at step 802 until the required inputs have been received (e.g., from first comparison circuitry 100). However, if the selected portion of each of the inputs has been received, then the process can continue to step 804 at which the selected portion of the second result representing the extreme data value (maximum or minimum) of the second set of comparison values is determined (e.g., as described with reference to FIGS. 4 and 6). This step can take place before any of the less significant portions of the second set of comparison values have been received. For example, the approaches shown in FIGS. 4 and 6 only require bit [N] and higher bits of the inputs to determine bit [N] of the result.

At step 806, the determined portion of the second result may be provided to a further level of comparison circuitry, or may be output as a final result.

At step 808, it is determined whether there are any further portions of the second set of comparison values less significant than the selected portion. If so, then the next most significant portion is selected at step 810 and the process returns to step 802. If there are no further portions, then the second comparison operation is complete at step 812.

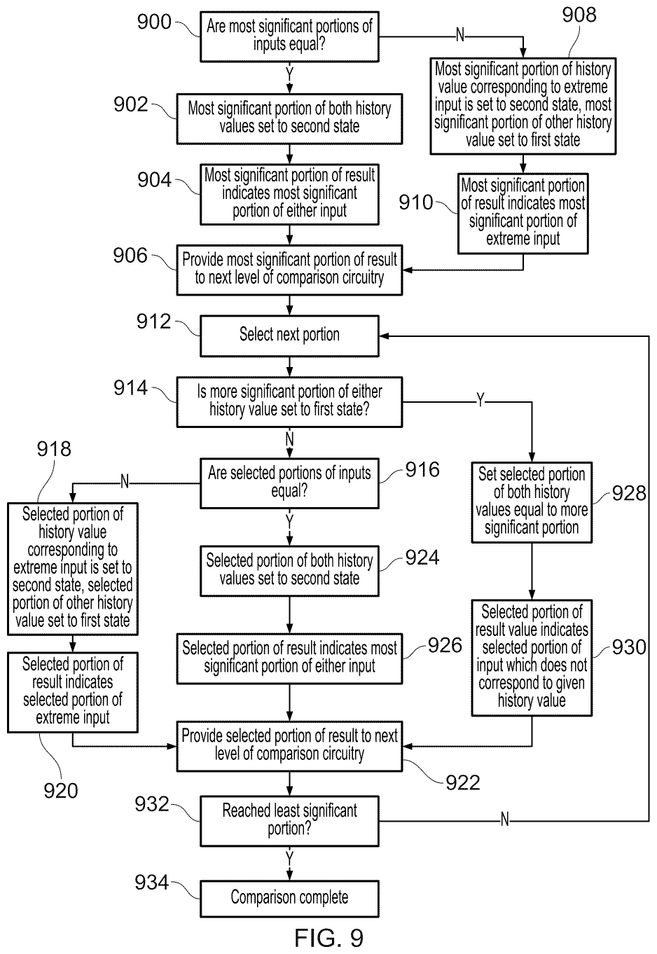

FIG. 9 is a flow diagram illustrating a method of using history values to perform the first or second comparison operation between two comparison values, for example as illustrated in FIGS. 4 and 6.

At step 900, at least the most significant portions of a set of comparison values have been provided to the comparison circuitry, and the comparison circuitry determines whether the most significant portions of the comparison values are equal. If so, then it cannot yet be determined which of the inputs is larger and hence neither input can be killed. Therefore, at step 902 the most significant portion of both of the history values is set to a second state (e.g., 0 in FIGS. 4 and 6). As the most significant portions of both comparison values are equal, the most significant portion of the result (max or min) is the same as both comparison values, so at step 904 the most significant portion of the result is selected based on the most significant portion of either input value. At step 906, the most significant portion of the result may be provided to a subsequent level of comparison circuitry (e.g., from the first comparison circuitry 100 to the second comparison circuitry 102), or as an output from the comparison circuitry.

If at step 900 it was instead determined that the most significant portions of the inputs were unequal, then an extreme value can be determined based on the most significant portion. At step 908 the most significant portion of the history value corresponding to the extreme input is set to the second state and the history value corresponding to the other input is set to the first state to kill the other input. This will be propagated through the history value (as discussed below) so that each subsequent portion is selected from the extreme comparison value. At step 910, the most significant portion of the result is selected based on the most significant portion of the extreme (max or min as the case may be) input, and is output at step 906.

At step 912, the comparison operation moves on to select the next portion, in reducing order of significance, to determine the next portion of the result based on the next portion of each of the comparison values. This step may involve determining that the selected portion of each input is available to the comparison circuitry (and waiting until they are available if not).

At step 914, it is determined whether the adjacent more significant portion of either of the history values is set to the first state (indicating a killed input). If so, then one of the inputs has, in a more significant portion, been determined to be the extreme data value. In this case, the history values are propagated and the selected portion of the result is selected based on the non-killed input. At step 928 the selected portion of both history values is set to the same value as the adjacent more significant portion (propagating the kill signal). At step 930 the selected portion of the result is selected based on the selected portion of the non-killed input, and at step 922 the selected portion of the result is output to a further level of comparison circuitry (or provided as an overall comparison output).

If the more significant portion of neither history value is set to the first state (no inputs have been killed), then at step 916 it is determined whether the selected portions of the inputs are equal. If so, then it cannot yet be determined which of the inputs is larger and hence neither input can be killed. Therefore, at step 924 the selected portion of both of the history values is set to the second state (e.g., 0 in FIGS. 4 and 6). As the selected portions of both comparison values are equal, the selected portion of the result (max or min) is the same as either comparison value, so at step 926 the selected portion of the result is selected based on the selected portion of either input value, and at step 922 the selected portion of the result is output to a further level of comparison circuitry (or provided as an overall comparison output).

If at step 916 it is determined that the inputs are not equal, then an extreme value can be determined based on the selected portion. At step 918 the selected portion of the history value corresponding to the extreme input is set to the second state and the history value corresponding to the other input is set to the first state to kill the other input. This will be propagated through the history value (e.g., at step 928) so that each subsequent portion is selected from the extreme comparison value. At step 920, the selected portion of the result is selected based on the selected portion of the extreme (max or min as the case may be) input, and is output at step 922.

At step 932, it is determined whether the selected portion is the least significant portion of the inputs. If so, then at step 934 the comparison is complete. If not, then the process returns to step 912 to select the next portion.

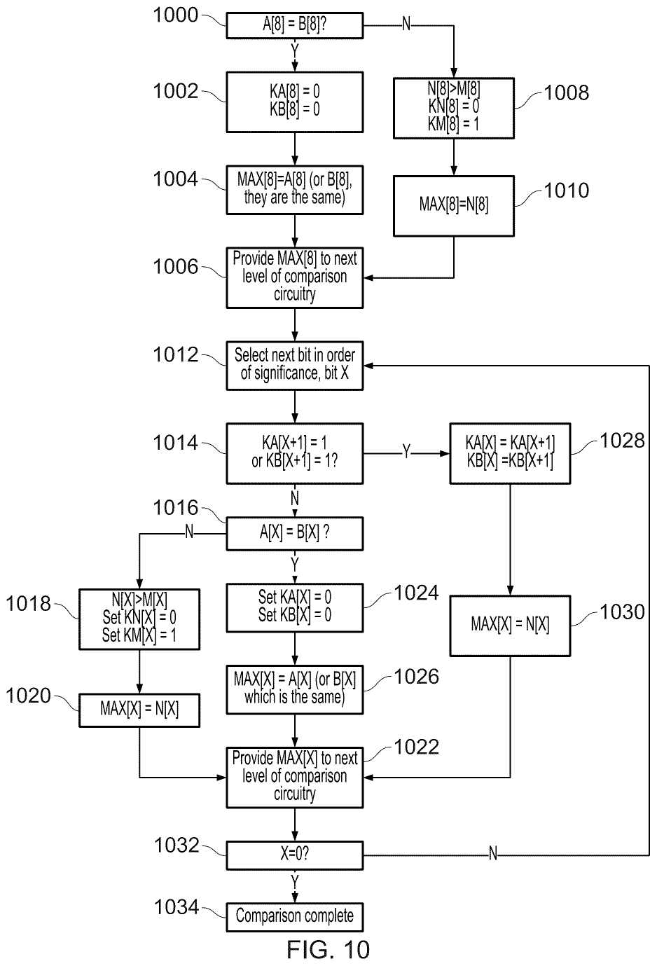

FIG. 10 provides a specific example of the method shown in FIG. 9 for the algorithm shown in FIG. 4 to determine the maximum value of the inputs A and B. Each step shown in FIG. 10 corresponds to the similarly numbered step in FIG. 9.

At step 1000, it is determined whether the most significant bits (MSB) of A and B are equal. If not, then the notation is adopted that the larger value is N and the smaller value M. At step 1008 the MSB of the kill values are set such that KN[8]=0, KM[8]=1 to kill the input M. Bit [8] of the result is selected at step 1010 from the larger input such that MAX[8]=N[8], and output at step 1006. If A[8]=B[8] then both kill values are set to 0 at step 1002, and MAX[8] is selected from either input at step 1004, before MAX[8] is output at step 1006.

At step 1012 the next bit, X, is selected. For example, if the previously selected bit was bit [8], then X=7. At step 1014, it is determined whether either input has been killed by checking whether either of KA[X+1] or KB[X+1] is set to 1. If so, then the kill value is propagated at step 1028 by setting KA[X+1]=KA[X] and KB[X+1]=KB[X], and bit X of the result is selected from the maximum input (N[X] using the notation adopted in 1008, where KN[X+1]=0), and output at step 1022.

If neither input has been killed, then it is determined whether A[X]=B[X] at step 1016. If not, then the notation is adopted that the larger value is N and the smaller value M. At step 1018 the MSB of the kill values are set such that KN[X]=0, KM[X]=1 to kill the input M. Bit [X] of the result is selected at step 1020 from the larger input such that MAX[X]=N[X], and output at step 1022. If neither input has been killed and A[X]=B[X], then at step 1024 neither kill value is set, so KA[X]=KB[X]=0, and the output is selected from either input, which are equal, so MAX[X]=A[X]=B[X], and the result is output at step 1022.

At step 1032 it is determined whether X as selected at step 1012 is equal to 0, and if so then the comparison is complete. If not, the process returns to step 1012 to select the next value of X by decrementing X.

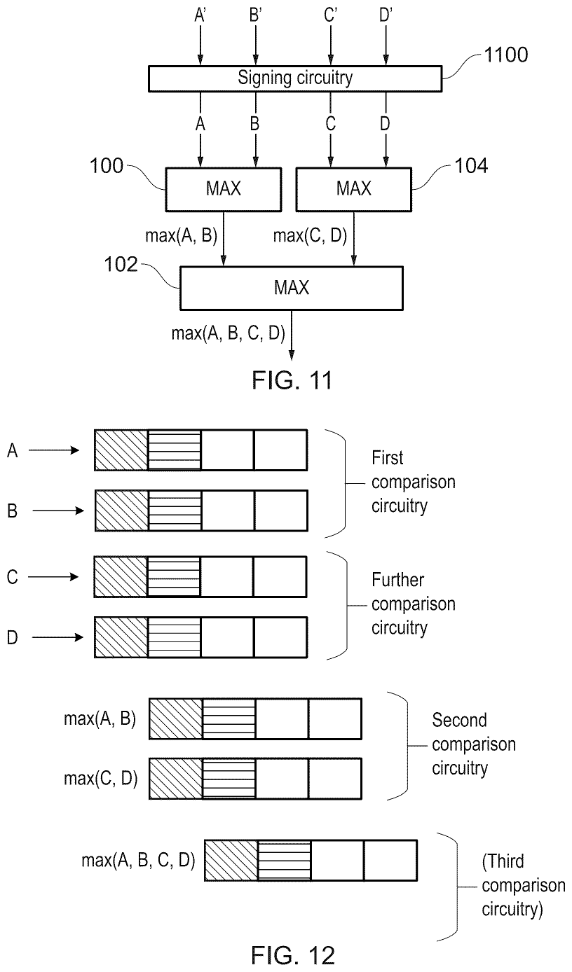

FIG. 11 schematically illustrates a full 2-level binary tree for determining a maximum value from four inputs. FIG. 11 therefore includes two instances of first comparison circuitry 100 at a first level (one of which is referred to as the further comparison circuitry 104) and one instance of second comparison circuitry 102 at a second level. The operation of the tree shown in FIG. 11 is the same as the tree shown in FIG. 1 when the further comparison circuitry 104 is provided.

FIG. 11 illustrates signing circuitry 1100 for modifying signed two's complement inputs A′-D′ to make them suitable for comparison using the approach illustrated in FIGS. 4 and 6. The signing circuitry adds an additional most significant bit to the inputs which is the inverse of the sign bit, as shown in FIG. 5. Although not shown in FIG. 11, complementary unsigning circuitry may also be provided after the final stage of the comparison (after the second comparison circuitry 102) to remove the most significant bit from the result, to remove the bit introduced by the signing circuitry. In an alternative approach, the signing circuitry could instead invert the most significant bit (the sign bit) of the inputs, rather than adding the inverted bit to the most significant side of each input. The unsigning circuitry could then invert the most significant bit of the result value of the comparison before it is provided as an output.

FIG. 12 illustrates relative timing of the comparison operations performed using the circuitry shown in FIG. 11. FIG. 12 is arranged in a similar way to FIG. 2, but additionally shows the relative timing of operations performed at the first comparison circuitry 100 and the further comparison circuitry 104. In particular, it will be seen that the operations performed at the first and further comparison circuitry, which are independent from each other, may be performed concurrently. The second comparison operation at the second comparison circuitry can begin for each portion when that portion of both inputs, max(A, B) and max(C, D), have been provided, and therefore are (at least) offset from the first operation by the time taken to compute one portion of the first result.

Although FIG. 11 does not include a third level of comparison, FIG. 12 also shows the delay that would be associated with a third comparison operation, relative to the first and second comparison operations. Again, the third comparison operation is only offset with respect to the second comparison operation by the time taken to compute one portion of the result, and therefore can be overlapped with the first and second comparison operations.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

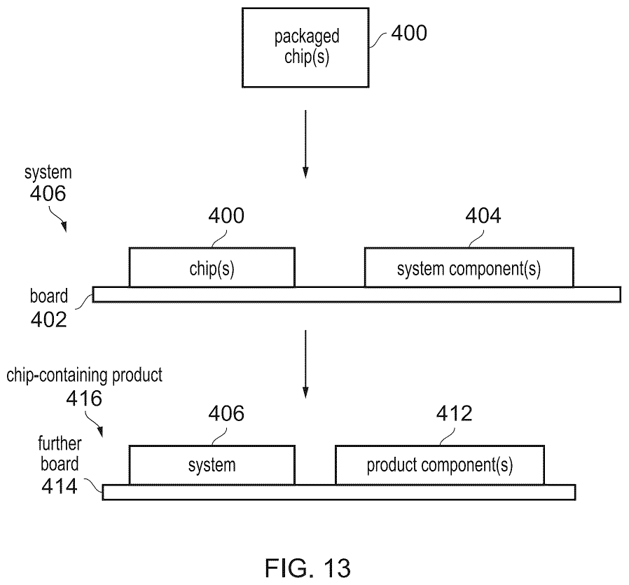

As shown in FIG. 13, one or more packaged chips 400, with the apparatus described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. modular chips which, when combined, provide the functionality of a larger chip) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company.

The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Some examples are set out in the following clauses:
1. An apparatus, comprising:
   first comparison circuitry configured to perform a first comparison operation to determine a first result representing a target extreme value of a first set of comparison values, the first comparison operation comprising determining portions of the first result in reducing order of significance starting from a most significant portion of the first result; and
   second comparison circuitry configured to perform a second comparison operation to determine a second result representing the target extreme value of a second set of comparison values represented by the first result and at least one further comparison value, the second comparison operation comprising determining portions of the second result in reducing order of significance starting from a most significant portion of the second result;
   wherein the first comparison circuitry is configured to provide a portion of the first result to the second comparison circuitry independent of whether a less significant portion of the first result has been determined; and
   the second comparison circuitry is configured to determine a given portion of the second result when a corresponding portion of each of the second set of comparison values has been made available to the second comparison circuitry, independent of whether less significant portions of each of the second set of comparison values have been made available to the second comparison circuitry.
2. The apparatus according to clause 1, wherein the second comparison circuitry and the first comparison circuitry are configured to perform the second comparison operation and the first comparison operation concurrently.
3. The apparatus according to clause 2, wherein the second comparison circuitry and the first comparison circuitry are configured to perform a more significant portion of the second comparison operation and a less significant portion of the first comparison operation concurrently.
4. The apparatus according to any preceding clause, wherein the target extreme value of the first set of comparison values and the target extreme value of the second set of comparison values are one of: a maximum and a minimum.
5. The apparatus according to any preceding clause, comprising third comparison circuitry configured to perform a third comparison operation to determine a third result representing the target extreme value of a third set of comparison values comprising the second result and at least one further comparison value, the third comparison operation comprising determining portions of the third result in reducing order of significance starting from a most significant portion of the third result;
   wherein the second comparison circuitry is configured to provide a portion of the second result to the third comparison circuitry independent of whether a less significant portion of the second result has been determined; and
   the third comparison circuitry is configured to determine a given portion of the third result when a corresponding portion of each of the third set of comparison values has been made available to the third comparison circuitry, independent of whether less significant portions of each of the third set of comparison values have been made available to the third comparison circuitry.
6. The apparatus according to any preceding clause, comprising further comparison circuitry configured to perform a further comparison operation to determine a further result representing a target extreme value of a further set of comparison values, the further comparison operation comprising determining portions of the further result in reducing order of significance starting from a most significant portion of the further result; wherein
   the second set of comparison values comprises the first result and the further result.
7. The apparatus according to any preceding clause, wherein at least one of the first set of comparison values and the second set of comparison values consists of two values.
8. The apparatus according to any preceding clause, wherein the portion of the first result and the given portion of the second result have a size of one bit.
9. The apparatus according to any preceding clause, wherein at least one predetermined portion of the first result comprises an inverse of the corresponding portion of the target extreme value of the first set of comparison values.
10. The apparatus according to any preceding clause, comprising comparison value signing circuitry configured to add an extension bit to the most significant side of each of a set of input two's complement values to provide the first set of comparison values,
   wherein the extension bit for a given input two's complement value is the inverse of a sign bit of the given two's complement value.
11. The apparatus according to any preceding clause, wherein the first comparison operation comprises generating a set of history values corresponding to the first set of comparison values, wherein each history value identifies whether a corresponding comparison value is the target extreme value of the first set of comparison values.
12. The apparatus according to clause 11, wherein for a given portion of a given history value, when more significant portions of the first set of comparison values are not equal, the given portion indicates whether the corresponding comparison value is the target extreme value of the first set of comparison values.
13. The apparatus according to any of clauses 11 and 12, wherein the first comparison circuitry is configured to set each portion of the given history value to one of a first state indicating that the corresponding comparison value is not the target extreme value and a second state, and the first comparison circuitry is configured to set a given portion of a given history value to the first state in response to determining either:
   an adjacent more significant portion of all of the set of history values is set to the second state and the given portion of one of the first set of comparison values which does not correspond to the given history value has the target extreme value among corresponding portions of the first set of comparison values; or
   a more significant portion of the given history value is set to the first state.
14. The apparatus according to any of clauses 11 to 13, wherein the first comparison circuitry is configured to determine a given portion of the first result based on the given portion of the first set of comparison values and an adjacent more significant portion of the set of history values.
15. The apparatus according to any preceding clause, wherein the first comparison circuitry and the second comparison circuitry form adjacent nodes in a binary tree of 2-input comparators.
16. A system comprising:
   the apparatus of any preceding clause, implemented in at least one packaged chip;
   at least one system component; and
   a board,
   wherein the at least one packaged chip and the at least one system component are assembled on the board.
17. A chip-containing product comprising the system of clause 16, wherein the system is assembled on a further board with at least one other product component.
18. A method, comprising:
   performing a first comparison operation to determine a first result representing a target extreme value of a first set of comparison values, the first comparison operation comprising determining portions of the first result in reducing order of significance starting from a most significant portion of the first result;
   providing each portion of the first result to a second comparison operation independent of whether a less significant portion of the first result has been determined;
   performing the second comparison operation to determine a second result representing a target extreme value of a second set of comparison values represented by the first result and at least one further comparison value, the second comparison operation comprising determining portions of the second result in reducing order of significance starting from a most significant portion of the second result; and
   determining a given portion of the second result when a corresponding portion of each of the second set of comparison values has been made available, independent of whether less significant portions of each of the second set of comparison values have been made available.
19. Computer-readable code for fabrication of an apparatus comprising:
   first comparison circuitry configured to perform a first comparison operation to determine a first result representing a target extreme value of a first set of comparison values, the first comparison operation comprising determining portions of the first result in reducing order of significance starting from a most significant portion of the first result; and
   second comparison circuitry configured to perform a second comparison operation to determine a second result representing a target extreme value of a second set of comparison values represented by the first result and at least one further comparison value, the second comparison operation comprising determining portions of the second result in reducing order of significance starting from a most significant portion of the second result;
   wherein the first comparison circuitry is configured to provide each portion of the first result to the second comparison circuitry independent of whether a less significant portion of the first result has been determined; and
   the second comparison circuitry is configured to determine a given portion of the second result when a corresponding portion of each of the second set of comparison values has been made available to the second comparison circuitry, independent of whether less significant portions of each of the second set of comparison values have been made available to the second comparison circuitry.

In summary, an apparatus comprises first and second comparison circuitry to perform first and second comparison operations to determine first and second results representing a target extreme value of first and second sets of comparison values, the first and second comparison operations comprising determining portions of the first and second results in reducing order of significance starting from a most significant portion. The first comparison circuitry provides portions of the first result to the second comparison circuitry independent of whether any a less significant portion of the first result has been determined, and the second comparison circuitry determines a given portion of the second result when a corresponding portion of each of the second set of comparison values has been made available to the second comparison circuitry, independent of whether any less significant portions of each of the second set of comparison values have been made available to the second comparison circuitry.

In the present application, the words “configured to . . .” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: A, B and C” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus, comprising:
first comparison circuitry configured to perform a first comparison operation to determine a first result representing a target extreme value of a first set of comparison values, the first comparison operation comprising determining portions of the first result in reducing order of significance starting from a most significant portion of the first result; and
second comparison circuitry configured to perform a second comparison operation to determine a second result representing the target extreme value of a second set of comparison values represented by the first result and at least one further comparison value, the second comparison operation comprising determining portions of the second result in reducing order of significance starting from a most significant portion of the second result;
wherein the first comparison circuitry is configured to provide a portion of the first result to the second comparison circuitry independent of whether a less significant portion of the first result has been determined; and
the second comparison circuitry is configured to determine a given portion of the second result when a corresponding portion of each of the second set of comparison values has been made available to the second comparison circuitry, independent of whether less significant portions of each of the second set of comparison values have been made available to the second comparison circuitry.

2. The apparatus according to claim 1, wherein the second comparison circuitry and the first comparison circuitry are configured to perform the second comparison operation and the first comparison operation concurrently.

3. The apparatus according to claim 2, wherein the second comparison circuitry and the first comparison circuitry are configured to perform a more significant portion of the second comparison operation and a less significant portion of the first comparison operation concurrently.

4. The apparatus according to claim 1, wherein the target extreme value of the first set of comparison values and the target extreme value of the second set of comparison values are one of: a maximum and a minimum.

5. The apparatus according to claim 1, comprising third comparison circuitry configured to perform a third comparison operation to determine a third result representing the target extreme value of a third set of comparison values comprising the second result and at least one further comparison value, the third comparison operation comprising determining portions of the third result in reducing order of significance starting from a most significant portion of the third result;
wherein the second comparison circuitry is configured to provide a portion of the second result to the third comparison circuitry independent of whether a less significant portion of the second result has been determined; and
the third comparison circuitry is configured to determine a given portion of the third result when a corresponding portion of each of the third set of comparison values has been made available to the third comparison circuitry, independent of whether less significant portions of each of the third set of comparison values have been made available to the third comparison circuitry.

6. The apparatus according to claim 1, comprising further comparison circuitry configured to perform a further comparison operation to determine a further result representing a target extreme value of a further set of comparison values, the further comparison operation comprising determining portions of the further result in reducing order of significance starting from a most significant portion of the further result; wherein
the second set of comparison values comprises the first result and the further result.

7. The apparatus according to claim 1, wherein at least one of the first set of comparison values and the second set of comparison values consists of two values.

8. The apparatus according to claim 1, wherein the portion of the first result and the given portion of the second result have a size of one bit.

9. The apparatus according to claim 1, wherein at least one predetermined portion of the first result comprises an inverse of the corresponding portion of the target extreme value of the first set of comparison values.

10. The apparatus according to claim 1, comprising comparison value signing circuitry configured to add an extension bit to the most significant side of each of a set of input two's complement values to provide the first set of comparison values,
wherein the extension bit for a given input two's complement value is the inverse of a sign bit of the given two's complement value.

11. The apparatus according to claim 1, wherein the first comparison operation comprises generating a set of history values corresponding to the first set of comparison values, wherein each history value identifies whether a corresponding comparison value is the target extreme value of the first set of comparison values.

12. The apparatus according to claim 11, wherein for a given portion of a given history value, when more significant portions of the first set of comparison values are not equal, the given portion indicates whether the corresponding comparison value is the target extreme value of the first set of comparison values.

13. The apparatus according to claim 11, wherein the first comparison circuitry is configured to set each portion of the given history value to one of a first state indicating that the corresponding comparison value is not the target extreme value and a second state, and the first comparison circuitry is configured to set a given portion of a given history value to the first state in response to determining either:
an adjacent more significant portion of all of the set of history values is set to the second state and the given portion of one of the first set of comparison values which does not correspond to the given history value has the target extreme value among corresponding portions of the first set of comparison values; or
a more significant portion of the given history value is set to the first state.

14. The apparatus according to claim 11, wherein the first comparison circuitry is configured to determine a given portion of the first result based on the given portion of the first set of comparison values and an adjacent more significant portion of the set of history values.

15. The apparatus according to claim 1, wherein the first comparison circuitry and the second comparison circuitry form adjacent nodes in a binary tree of 2-input comparators.

16. A system comprising:
the apparatus of claim 1, implemented in at least one packaged chip;
at least one system component; and
a board,
wherein the at least one packaged chip and the at least one system component are assembled on the board.

17. A chip-containing product comprising the system of claim 16, wherein the system is assembled on a further board with at least one other product component.

18. A method, comprising:
performing a first comparison operation to determine a first result representing a target extreme value of a first set of comparison values, the first comparison operation comprising determining portions of the first result in reducing order of significance starting from a most significant portion of the first result;
providing each portion of the first result to a second comparison operation independent of whether a less significant portion of the first result has been determined;
performing the second comparison operation to determine a second result representing a target extreme value of a second set of comparison values represented by the first result and at least one further comparison value, the second comparison operation comprising determining portions of the second result in reducing order of significance starting from a most significant portion of the second result; and
determining a given portion of the second result when a corresponding portion of each of the second set of comparison values has been made available, independent of whether less significant portions of each of the second set of comparison values have been made available.

19. A non-transitory computer-readable medium storing computer-readable code for fabrication of an apparatus comprising:
first comparison circuitry configured to perform a first comparison operation to determine a first result representing a target extreme value of a first set of comparison values, the first comparison operation comprising determining portions of the first result in reducing order of significance starting from a most significant portion of the first result; and
second comparison circuitry configured to perform a second comparison operation to determine a second result representing a target extreme value of a second set of comparison values represented by the first result and at least one further comparison value, the second comparison operation comprising determining portions of the second result in reducing order of significance starting from a most significant portion of the second result;
wherein the first comparison circuitry is configured to provide each portion of the first result to the second comparison circuitry independent of whether a less significant portion of the first result has been determined; and
the second comparison circuitry is configured to determine a given portion of the second result when a corresponding portion of each of the second set of comparison values has been made available to the second comparison circuitry, independent of whether less significant portions of each of the second set of comparison values have been made available to the second comparison circuitry.
